(19) United States
(12) Patent Application Publication
(10) Pub. No.: US 2016/0335598 A1
(43) Pub. Date: Nov. 17, 2016

(54) Multi-Destination Instrumentation Delivery System for Solar System Exploration to create and sustain commercial, heavy industrial and research opportunities

(71) Applicant: John Aylmer, Winter Park, FL (US)

(72) Inventor: John Aylmer, Winter Park, FL (US)

(21) Appl. No.: 15/202,633

(22) Filed: Jul. 6, 2016

(51) Int. Cl. G06Q 10/10; B64G 99/00; B64G 1/40; B64G 1/14; B64G 1/54

(52) U.S. Cl. CPC G06Q 10/103; B64G 1/14; B64G 1/543; B64G 1/405; B64G 9/00

(57) ABSTRACT

This invention is a continuum of enabling technology using related patent applications to baseline methods, and apparatus' allowing a paradigm shift to perform a plurality of deep space mission objectives using a Multi-Destination Instrumentation Delivery System (DS) spacecraft. The DS is a 100% reusable craft, prepositioned in GEO orbit that performs various tasks including: solar system exploration; planetary science missions; provides space platforms for proving emergent innovative technology concepts; enhanced instrument and planetary measurement and performance capabilities; increased science, commercial and military payloads on future interplanetary spacecraft; and cultivate an achievable profitable commercial business model and supportive infrastructure

### CROSS REFERENCE To RELATED APPLICATIONS

This application claims are divisional and benefits of U.S. Provisional Application Ser. No. 62/282,147 filed on 17 Jul. 2015 and which is hereby incorporated by reference in its entirety; U.S. Provisional Application Ser. No. 62/177,113 filed on 5 Mar. 2015; U.S. Provisional Application Ser. No. 62/284,405 filed on 29 Feb. 2015 and which is hereby incorporated by reference in its entirety; U.S. Provisional Application Ser. No. 62/176,253 on 12 Feb. 2015 and which is hereby incorporated by reference in its entirety.

### JOINT RESEARCH AGREEMENTS

Does not apply.

### SEQUENCE LISTING

Does not apply.

### STATEMENT REGARDING PRIOR DISCLOSURES

Does not apply.

### BACKGROUND

The National Aeronautics and Space Act had been passed on Jul. 29, 1958, disestablishing NASA's predecessor, the National Advisory Committee for Aeronautics (NACA). On Jul. 29, 1958, Eisenhower signed the National Aeronautics and Space Act, establishing NASA. When it began operations on Oct. 1, 1958, NASA absorbed the 46-year-old NACA intact; its 8,000 employees, an annual budget of USD $100 million, three major research laboratories namely Langley Aeronautical Laboratory, Ames Aeronautical Laboratory, and the Lewis Flight Propulsion Laboratory and two small test facilities.

Since 1958, there were many successful space flight missions both unmanned and manned which are too numerous to highlight within this background. Currently, the Solar System Exploration Directorate (Code 600) has become the largest research organization in the world and is composed of four major divisions. One division, the Solar System Division (Code 690) is chartered to conduct theoretical and experimental research to explore the solar system and understand the formation and evolution of planetary systems. Laboratories within the Division investigate areas as diverse astrochemistry, planetary atmospheres, extra-solar planetary systems, earth science, planetary geodynamics, space geodesy, and comparative planetary studies. Code 690 conducts theoretical and experimental research to explore the solar system and understand the formation and evolution of planetary systems

The common denominator between NASA and European Space Agency (ESA) is the Solar System Exploration (SSE) Theme. This Theme is a three-pronged quest to explore the formation and evolution of our solar system and Earth within it, seeks the origins of life and its existence beyond Earth, and charts our destiny within the solar system. The SSE program will examine potentially habitable environments, search for life, and attempt to understand how solar system processes affect the future of Earth and humanity.

<<Insert Table 1>>

To better understand the embodiments and artwork of this invention, it is important to identify with the purpose and objectives of the SSE Technology and Advanced Concepts (SSETAC) as presented in the Performance Measurement at Table 1. These serve to baseline the material gaps that this invention is to resolve.

The SSETAC purpose is to develop advanced technologies needed for specific deep space science missions. This process begins with mission studies where scientists work collaboratively with technologists and mission designers to develop the most effective alignment of technology development programs with future mission requirements. This collaboration enables intelligent technology investment decisions through detailed analysis of the trade-offs between design considerations and cost. Technologies critical to the success of future SSE missions include, but are not limited to: new propulsion systems and techniques that enable greater mission flexibility, improved radioisotope power systems, advanced communications systems, and advanced avionics capabilities.

The SSETAC objective is to push the state of the art in planetary exploration which underscores the need for larger, more powerful In-Space Power and Propulsion (ISPP) systems. Also, Dr. Harold White's proposed DARPA Warp Drive propulsion system is included with funding in question. These ISPP systems embrace employing the radioisotope power systems (RPS) and electric propulsion systems which were an integral part of the cancelled Project Prometheus providing nuclear propulsion systems for future spacecraft. This cancelled project has been resurrected under contract through Ad/Astra Rocket Company to develop the Variable Specific Impulse Magnetoplasma Rocket (VASIMR®) which is an electromagnetic thruster for spacecraft propulsion for use in many in-space applications. The VASIMR® propulsion system will join NASA's new Exploration Systems Enterprise (ESE) enabling quicker deployment of next generation instrument technology for use on future solar system missions. In addition, VASIMR® is one major embodiment of this invention supporting the ESE initiatives.

With the above cited SSETAC purpose and objectives, the stakeholders need to carefully examine the entire space life cycle cost model to include all space endeavors in order to provide a cost effective unified space program. The new Space Launch Systems (SLS) provides an example showing the approximate target cost of $500 million per launch. The SLS will not be available until 2023 with untold billions spent on developing, testing, sustainment and training. In its initial incarnation, the SLS will be capable of lifting 70 metric tons of payload. NASA eventually plans to build several variants of the rocket, allowing it to carry 105 tons in one configuration and 130 tons in another. Simply, the freight costs for the SLS remains at a staggering $7,142,857 per ton or about $3,571 per pound carried aloft on a one way trip. More weight added would require more advanced boosters. It is clear that employment will be created or sustained with the current suppliers. Although the SLS target costs are extremely high, the average price of a mission, accounting for all current firm contracts for Atlas and Delta launch services is a range from $100 to $225 million per launch. This includes all missions Department of Defense (DoD), NASA, commercial, Atlas V 401 through Delta IV Heavy (stick rockets). The majority of these launches are for Evolved Expendable Launch Vehicle (EELV) Launch Capabilities contracts that have funds for very well-defined national security space requirements permitting the Air Force to launch exactly when and where it needs to launch.

Without question, the NASA space initiatives for the SLS and Mars are platformed on brilliant engineering and planning efforts by the Government Agency. Yet, when compared to the above SSETAC purpose and objectives, it is an oxymoron where budget and implementation is pushing hard to relive 1962 Apollo technology by using extremely expensive one time use, bigger stick rockets. These same brilliant engineers and scientists' should focus on resolving the SSETAC materiel gaps to meet their mission objectives. These SSETAC mission gaps could be achieved through a realistic budget with significant emphasis on project formulation to ensure adequate preparation of project concepts/plans with mitigation of high-risk aspects of the project essential to position the project for the highest probability of mission success, as found on page SUM-13 of the FY 2017 Budget Request Executive Summary.

The embodiments of this invention draw heavily upon licensed patented enabling technology from Space Crossroads, LLC which will provide ‘extremely cost effective’ and ‘strict design for commercial profit’ methods to sustain trans-orbital and solar system transportation pipelines for orbital and planetary infrastructure development.

When fully employed this family of patented enabling technology, this invention provides a procedural embodiment guide to construction and exhibited suggested mission profile of a Multi-Destination Instrumentation Delivery System (DS) for Solar System, Exoplanet Exploration, and filling SETAC mission gaps.

### DETAILED DESCRIPTION OF THIS INVENTION

In this present invention, a paradigm shift in deep space research exploration is introduced employing uniform methods of acquisition and sustainment supporting development of a family of new planetary major equipment (PME) apparatuses. Within this PME family, a Multi-Destination Instrumentation Delivery System (DS) is to deliver and a set-up autonomous infrastructure to reduce time and operational costs to collect research data; and enabling multiple Solar System (SSEP) and Exoplanets Exploration (ExEP) events to occur within a singular mission.

An unloaded configuration DS, [Herein called: DS 7] at FIGS. 3, 4, 5, 8, and 9 is a 100% reusable PME spacecraft assembled in orbit and prepositioned in GEO orbit between exploration missions. The function of an unloaded configuration DS 7 at FIGS. 3, 4, 5, 8, and 9 mimics the cargo handling capabilities and methods of an ocean going container ship and can be loaded with instrumentation and planetary containers; communication and navigational relay modules deployed while on route; and an array of other research devices.

When deployed on a new mission, an unloaded configuration DS 7 at FIGS. 3, 4, 5, 8 and 9 operating and navigation systems are a combination of remotely piloted control, autonomous operation, and/or human control which is determined by the first embodiment. While on a deep space mission, onboard DS operating software and sensors systems monitor the instrumentation health. Each instrumentation package has its own specialized container which shields the instruments from all types of radiation and other environmental hazards generally encountered.

A typical Solar System Exploration (SSE) an unloaded configuration mission DS 7 at FIGS. 3, 4, 5, 8 and 9 starts at the first embodiment, which is illustrated at FIG. 1. This figure exhibits uniform repeatable task flow methods of planning, preparation, and mission execution, as defined by three swim lanes.
In the first swim lane, a new SSE planetary research program begins with scientists of a government agency or academia requesting and securing container space or an entire Delivery System for their projects. Upon project acceptance, a new project documentation (NPD) package is created that will manage, engineer, contract for production and related services, and transport into GEO orbit all required components.
The second swim lane presents those mission preparation tasks focused on bringing into a sustainable operation space docks and a DS under new construction or modifications. Tasks performed are the continuous engineering, building, maintaining, and testing the newest DARPA and NASA propulsion systems that can now be mounted on future DS. Another related task in this lane, an area of the space dock responsible to build and test is mounted on a DS. The DS will transport all surface habitation and industrial modules, transportation hubs, heavy construction equipment, and all related systems to create self-sustaining comfortable planetary infrastructures.
The third swim lane is those tasks related to the actual SSE and Exoplanet mission execution. The mission execution for the deployment of the scientist research packages have been defined at the beginning of this embodiment. When a mission is executed, it has been thoroughly trained, system approved, and simulated as defined by the new project documentation packages.

The Second Embodiment of this invention mirrors in its entirety the processing steps of non-provisional application Ser. No. 15/055,606 filed on 28 Feb. 2016 and illustrated at FIG. 2. This embodiment is guided and managed under new project documentation authorized under processing step 1. During the execution tasks within this embodiment, the processing steps 2 through 4 is where engineering data, component production, required delivery schedules, and contracts are awarded to multiple suppliers and manufacturers to build space docks 6 at FIGS. 3, 4, and 8 instrument packages 8 at FIGS. 4, 5, 6, 7, and 9 and a DS in a sampled loaded configuration 7A at FIGS. 6, 8, and 9. The processing steps 5 and 6 become the end state of this embodiment where a trans-orbital freight carrier 1 at FIG. 3 is loaded with its cargo and/or passengers and then flown to the orbital insertion point. The trans-orbital carrier 1 operational requirements are presented by non-provisional application Ser. No. 15/047,316 filed on 16 Feb. 2016.

The ‘end state’ of embodiment 2 exhibited at FIG. 2 naturally begin ‘start state’ of embodiment 3 exhibited at FIG. 3. The thrust of embodiment 3 are a plurality of methods for orbital delivery and off-loading cargo from a trans-orbital freight carrier 1. The cargo is robotically guided to in-situ assemblage area of the first DS 7 at FIG. 5 building the first mission. The first DS Space Dock complex 6 at FIGS. 3, 4, and 8 will be scheduled for completion later. The methods of embodiments 3 and 4 mirrors in its entirety of methods within the non-provisional application Ser. No. 15/048,670 filed on 19 Feb. 2016 and non-provisional application Ser. No. 14/998,744 filed on 9 Feb. 2016. Benefits of embodiment 3, that it exceeds the objective 1.3 of the 2014 NASA Strategic Plan, is the aggressive use of the pipeline methods employing a trans-orbital carrier 1 at FIG. 3. A fleet of carriers 1 provides a continuous daily round trip shipments, exhibited at FIG. 3, to a Space Dock or DS assemblage site dropping cost per pound by a projected 10% of current GSA schedule or 1000% less than the SLS costs.

The proceeding three embodiments have provided the continuous methods to create this 4th embodiment to build then sustain an operational DS space dock complex 6 at FIGS. 3, 4, and 8. Complex 6 would accelerate experimentation for employing a plurality of Artificial Gravity devices and modules that would sustain and determine the comfort zone parameters long term habitation and working conditions of this environment. To protect the crew compartments for long term habitation, a complex plurality of methods for radiation protection at FIG. 5 employing a water barrier for scattering properties in gamma-ray protection and combined with other polyethylene/Kevlar composites for other radiation and debris collection protection. Employing the methods of artificial gravity and radiation protection for crew safety would promote acceptance for commercial enterprises to maintain the complex and perform all tasks required.

Complex 6 at FIGS. 3, 4, and 8 is a multiple purpose specialized facility capable of closing the many of objective gaps of 2014 NASA Strategic Plan and requirements under the Exploration Technology and Development pages under ES pages of the 2017 NASA Budget estimates. As a commercially operated complex, the functions and methods performed under this embodiment will:
Enable the commercial space industry to provide contractor-owned and contractor-operated (CO-CO) facility to develop and expand core capabilities required to implement any DOD, NASA and all commercial client multi-destination strategies using the bare spacecraft DS 7 at FIGS. 3, 4, 5, 8 and 9 and turn into a mission ready loaded configuration spacecraft 7A at FIGS. 6, 8, and 9. With a DS 7 is prepositioned and operational at a Space Dock 6 or in the free-floating controlled mooring area, the need for a SLS or any ground launched support is negated by using the trans-orbital carrier 1. This method integrates several programs to streamline cargo handling decision-making processes, and enable a realistic affordable long-term human or remotely controlled exploration project to begin.
Provide the capabilities and develop the advance methods to support an in-situ assemblage 9 and outfitting area to build or modify, test and make ready for a deep space mission any configuration of a DS 7 exhibited at FIGS. 3, 4, 5, 8 and 9.
Provide for a science and engineering environment performing a plurality of methods to service and upgrade satellites 10 at FIG. 4. In addition, provide the capabilities to build more advanced and larger telescopes. During the methods and procedures for satellite maintenance, the sister Pu-238 Power Pack Complex 20 will provide fusion power pack containers for satellites 10, telescope and instrumentation containers 8 and larger containers for complexes 6, 20 and the DS spacecraft.
Provide the capabilities and develop the advance methods to support an in-situ assemblage 9 and outfitting area of any type of instrumentation package containers 8. Resembling a reusable ISO-shipping container, an instrumentation container is designed to protect the satellites and/or instrument packages from the radiation environment during the passage to the planetary deployment site. At 6A at FIG. 5 a typical instrumentation container shell is surrounded by four exterior thick walls comprised of a water barrier for gamma radiation protection and other polyethylene/Kevlar composite materials for other types of radiation and debris protection. During a flight to the designated planet, an instrumentation package resides inside a container shell which receives continuous power from a loaded configuration DS 7A at FIGS. 8 and 9 while software monitors the health of the package. After returning from a deep space mission, these containers 8A at FIG. 9 are outfitted and made ready for the next exploration mission.
Provide for a secondary or sister complex and perform secure methods for the large scale production and management of Plutonium 238 (Pu-238) and other fusion materials under Department of Energy (DOE) control. This complex will build, overhaul, material dispose, test and inventory Power Package Containers. Containers 12A at FIG. 5 are a quick disconnect plug and play configuration designed for remote handling and used as electrical power systems (battery packs) for complexes, instrumentation packages, spacecraft, and planetary and/or mining infrastructures. This secondary complex is a critical for sustaining and expanding the commercial and NASA's current supply of Pu-238 and other fusion materials while it negates the need for environmental safety and permits rocketing small amounts of radioactive materials into space.
Provide for continual module expansion for commercial enterprises to accomplish all future anticipated research and construction methods, systems development procedures, construction of any type of spacecraft, planetary habitant/mining infrastructures, and asteroid mining.

Eventually, embodiment 4 will become eventually become operational. Nevertheless, embodiment 5 will be made operational first because of the need for a deep space device, or spacecraft, enabling the capabilities for a DS 7. This invention is not responsible for the design and construction of any instrumentation packages mounted on a loaded configuration DS 7A. Rather, an unloaded configuration DS 7 primarily functions as a delivery system to multiple destinations as specified by embodiment 1 at FIG. 1 to deploy instrumentation packages as depicted at FIG. 9 to the designated planetary location. Key characteristics of this embodied deep space device are that:
It is assembled, outfitted, and made operational in high GEO orbit. The configuration, size and mass of a unloaded configuration DS 7 is irrelevant when all supplies and outfitting materials are delivered by a fleet of trans-orbital freight carriers 1 at FIG. 3 using its entirety of methods within the non-provisional application Ser. No. 15/048,670 filed on 19 Feb. 2016 and in its entirety non-provisional application Ser. No. 15/047,316 filed on 16 Feb. 2016.
DS Payload Mounting Frames 11A at FIG. 5 provide capabilities to mount the payloads on a loaded configuration 7A at FIG. 6 for multiple destinations delivery depicted at FIG. 8. The payload frames 11A at FIG. 5 designed to permit additional frames to be added as required or needed for specific mission requirements are defined by FIG. 1. Within the Frames 11A at FIG. 5, a maintenance tunnel 11B provides access from the Crew Compartment 11 to the Power Pack Inventory 12 and Propulsion Systems 13. The tunnel 11B side passage permits maintenance access to any container or devices. The tunnel is heavily sensored and wired for continuous health monitoring while avoiding any dangerous space walks. Material handling and maintenance drones 2 will provide external physical inspections and repairs.
An enormous payload mass of a fully loaded configuration DS 7A at FIGS. 6, 8, and 9 and requirement to expeditiously delivery instrumentation requires the need for four larger Variable Specific Impulse Magnetoplasma Rocket (VASMR®) engines 13 at FIG. 5 and helper Xenon-ION engines for continuous acceleration to the outer solar system FIG. 7 and return. These propulsion systems are fueled by Power Package Containers 12A at FIG. 5. When exhausted, the containers are internally stored 12 then returned for overhaul and recharged for reuse.
Another unloaded DS 7 configuration provides methods, procedures, instrumentation and mounting devices for advanced propulsion systems including Alcubierre Warp Drive Mechanics as conceptualized by Dr. Harold White, NASA Johnson Space Center.
A unloaded DS 7 has multiple operational modes of being remote controlled and crewed by astronauts and scientists.
All DS spacecraft remain in space where they are maintained in an ‘operational state’ and upgraded as new technology and systems are available.

Embodiment 6 presents a pay loaded mission ready DS 7A as presented at FIG. 6. The figure displays a theoretical multi-destination payload exhibited at FIG. 8. A scientific payload manifest for a mission is defined by the scientists at FIG. 1 and mission deployment is rehearsed in models and simulation. In this theoretical payload, the DS is transporting long and short haul communication modules 14 at FIG. 6, Planetary Ecosystem and Astrobiology Data Analysis Landing Modules 15 and three Keepler Telescopes 16. With this payload being assembled in GEO orbit, the scientific packages are larger with more advanced capabilities, the planetary exploration methods FIG. 8 and FIG. 9 of this one theoretical mission profile will deploy instrumentation package to study the:
Astrobiological and commercial profit potential of past or present environments on or under the Martian surface or subsurface.
Astrobiological and commercial profit potential of icy worlds of Europa, Ganymede, Enceladus, and Titan.
Solar system planets and their moons for astrobiological and commercial profit potential that could be developed into permanent habitant infrastructures for continuous sustainment and ability to build and expand industry and mining without earth support.
Deploying Keepler, Nuclear Spectroscopic Telescope Array (NuSTAR), X-ray Multi-Mirror Mission (XMM)-Newton telescopes 16 at FIG. 6 and other future telescopes 16 powered by smaller advanced Xenon-Ion propulsion systems with small fusion power packs 12A at FIG. 5.

As a fully loaded DS 7A at FIG. 6 departs on deep space mission, embodiment 7 displayed at FIG. 7 shows a theoretical deployment and placement of planetary orbital instrumentation packages 8A, 8B, laser-based space relay communications modules 14 and a planetary landing module 15 to determine the future commercial value of each planet.

The methods and processes of embodiment 7 are the placement and ensure continuous alignment of laser & near-infrared communications relay modules. Although space laser communications systems 14 are an ever emerging crosscutting technology, this invention and its related provisional applications previously cited provides the capabilities to rapidly build in orbit a new robust, highly advanced relay communications and navigational tracking beam infrastructure required by industrial and mining commercial space enterprises and NASA researchers. The communications methods of this infrastructure would initially provide for an ever expanding thru-put transferring rate at 622+ megabits per second, which is about five times the current state-of-the-art from lunar distances. A module 14 optical beam will be an approximate 12-inch green laser beam spiral wrapped in a blue laser to prevent distortion requiring a clear line of sight between all relay modules and with earth and the planetary deployed systems. Because the relay modules are permanently positioned in hostile deep space and planetary orbit environment, continuous maintenance and alignment is required. FIG. 5 displays the same radiation protective shell 14A as all other devices in this invention and is capable of supporting long term human habitation. The Space Dock 6 at FIGS. 3, 4, and 8 is responsible to assemble and make operational Unmanned Maintenance Space Barge with material handling drones 2 at FIG. 7 to remove, replace, align and repair any degraded performing relay module.

An essential functional element of embodiment 8 is directly drawn from methods of embodiment 7 as depicted at FIG. 7. FIG. 8 provides a suitable depiction of placing satellites 8B, communication modules 14 and a placement instrumented or equipment landing modules 15 at FIGS. 6, 7, and 9 on a watery moon or planet. Later, a plurality of electric drive, fusion powered heavy construction equipment (I.e. Caterpillar D7E) will be landed to aggressively research and to begin for profit commercial mining of a planets resources.

Embodiment 8 as depicted by FIG. 8 is a panoramic view of theoretical multi-destination solar system mission specified by embodiment 1. During the execution of this mission, the DS 7A payload will begin at earth station and travel to the icy world moons around Jupiter and sling-shot to Pluto. A Mission specialist or planetary scientist will release instrumentation 8B and communication relay modules 14.

As a loaded configuration DS 7A arrives at the dwarf Pluto planetary orbit, embodiment 9 is best depicted by a panoramic view in FIG. 9. A vast lack of information about this planet will require more specific DS missions. During these exo-pluto missions, mission specialists or planetary scientists will place and maintain instrumentation packages, flyable drones, and build and work in habitable planetary research infrastructure. In following missions, a loaded configuration DS 7A will deliver a plurality of electric drive, fusion powered heavy construction, and drilling equipment devices (I.e. Caterpillar D7EN-nuclear powered). Any equipment devices below 60 tons are carried aloft by the methods of a trans-orbital carrier 1 at FIG. 3 to the loading zone or Space Dock 6. The equipment devices are mounted into a landable container which then mounted on the DS 7A at FIG. 9. Once on a DS 7A, they transported to a planet, moon or Pluto. Pluralities of methods are performed where equipment containers are flown and gently landed on the planet's surface. Upon landing, another plurality of methods are evoked where equipment containers 15 are converted into a shelters protecting the equipments and capable of support human habitant for maintenance. Pluralities of methods that these equipments would perform provide more aggressive scientific research and to begin for profit commercial mining of a planets resources. A remote output would provide earth planetary defensive for deflecting foreign bodies with an earth trajectory.

The conclusion of any deep space mission and deployment of the entire payload of a loaded configuration DS 7A occurs when all embodiments and methods of this invention have been executed as displayed in FIGS. 8 and 9. A unloaded configuration DS 7 returns to the earth's GEO mission preparation area or when a Space Dock 6 becomes operational. It is anticipated that a returning DS 7 would return with defective packages or systems for repair, upgrade, or disposal, including the refurbishment of DS for another mission.

Upon arrival at the earth's GEO mission preparation, all embodiments of this invention will begin again from FIG. 1 tasks and methods.

### BRIEF DESCRIPTION OF THE DRAWINGS

The nine embodiments are supported by the following artwork:

FIG. 1 Event Flow Diagram of repeatable tasks and swim lane processes to bring an approved science research project from project start to mission completion and returned for next mission.

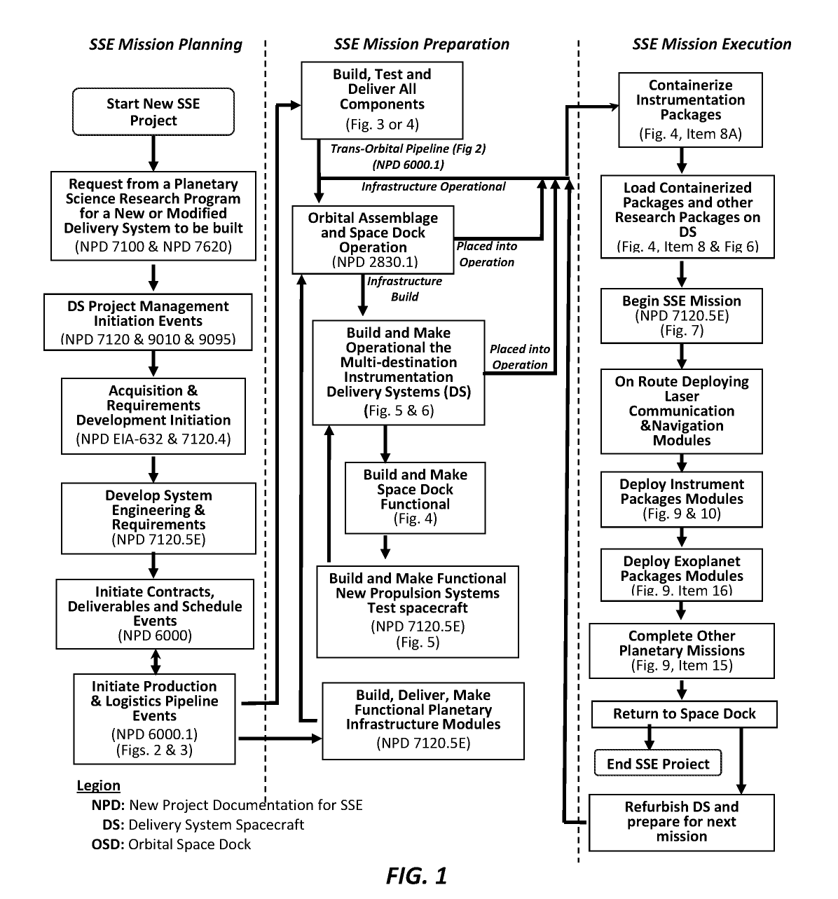

FIG. 2 Illustrative Process Flow Diagram of all project management tasks and pipeline processing events bringing materials to a fleet of trans-orbital carrier 1.

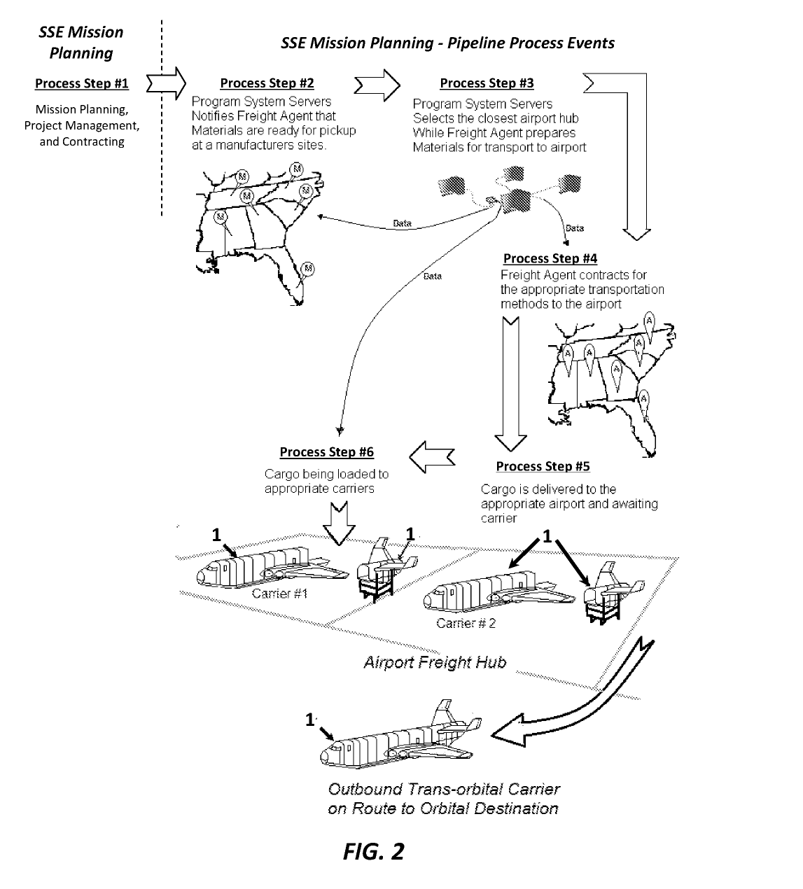

FIG. 3 Illustrative Process Flow Diagram of a fleet of trans-orbital carriers delivering construction materials. It is an evolutionary assemblage of delivered materials which could become a Space Dock 6 and/or a Delivery System Spacecraft 7.

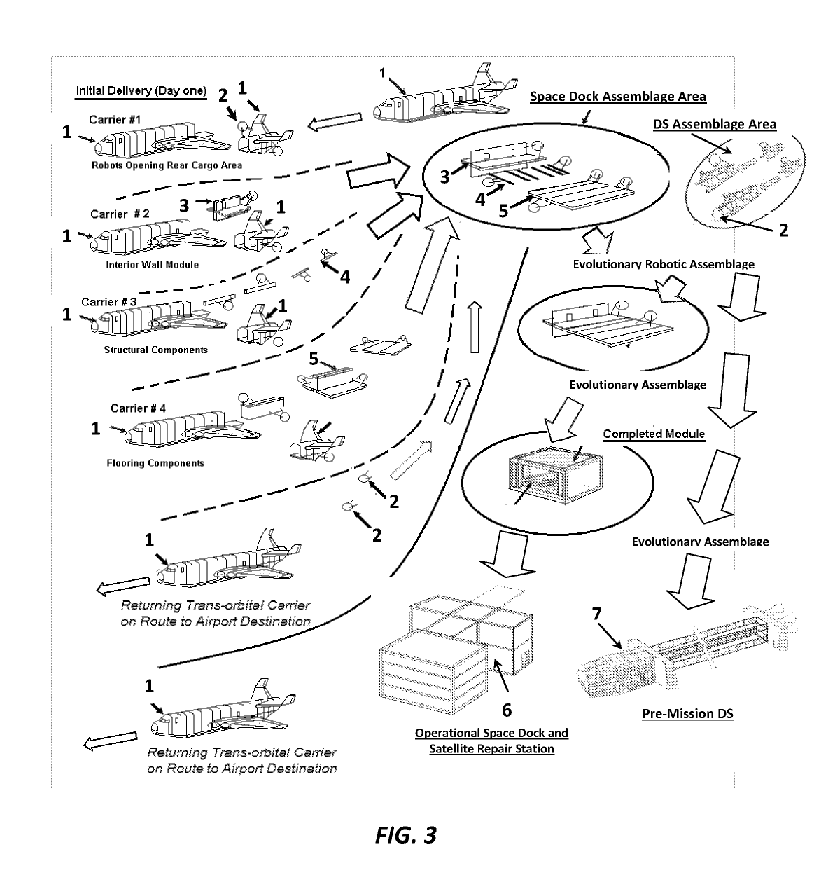

FIG. 4 Isometric view depicts a fully operational commercial space dock complex 6 and the sister PU-238 Power Pack Complex 20. The complex mission provides for complete assemblage, maintenance and loading payloads of a DS 7. Equally, earth's satellite are maintained or built and instrumentation packages are assembled and delivered to an awaiting DS 7A. The entire complex provides for artificial gravity and long term human habitant.

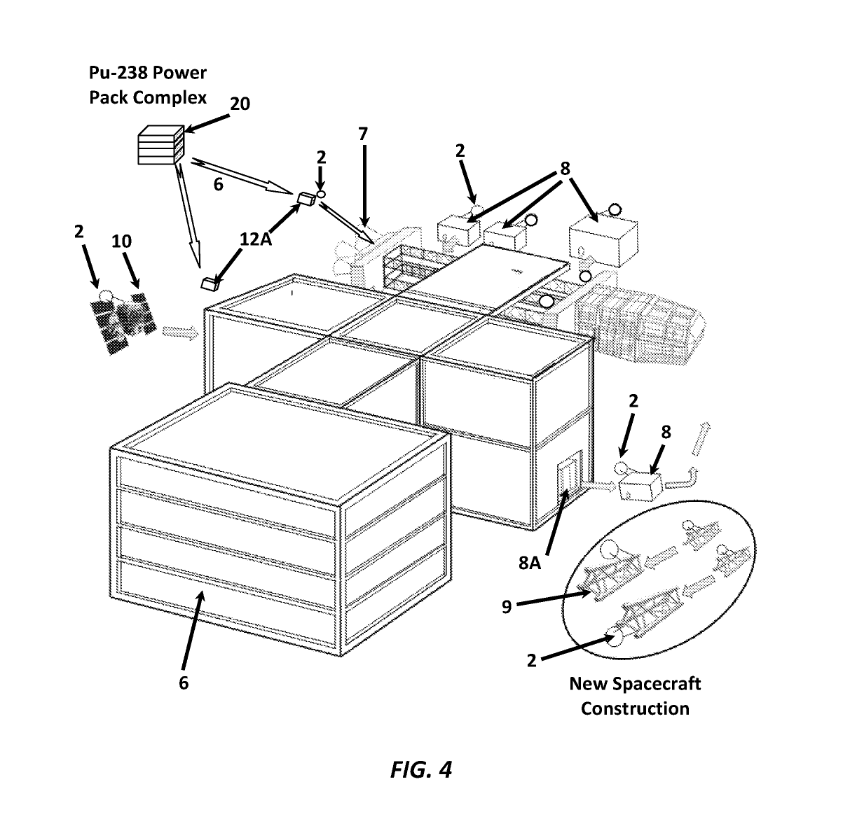

FIG. 5 Isometric and side view displaying the major components of a Delivery System Spacecraft 7. The inserted cutaway shows the universal wall systems providing exterior and interior radiation protection and equipment maintenance passageways to eliminate external space walks.

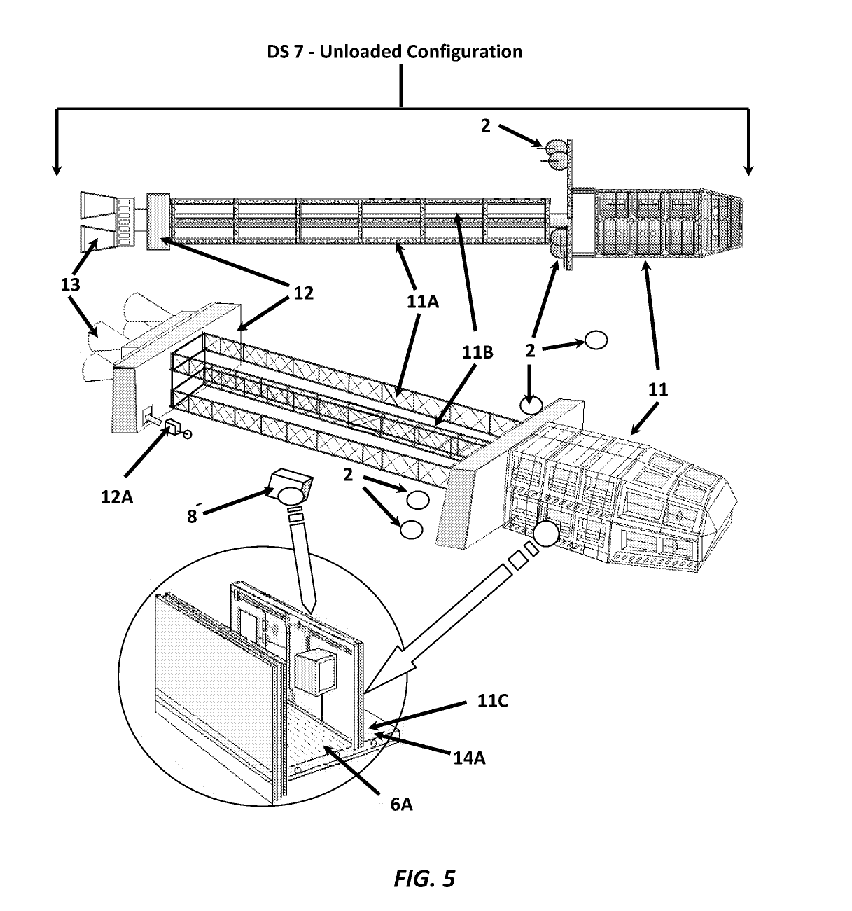

FIG. 6 Side view displaying a mission ready Delivery System Spacecraft 7A.

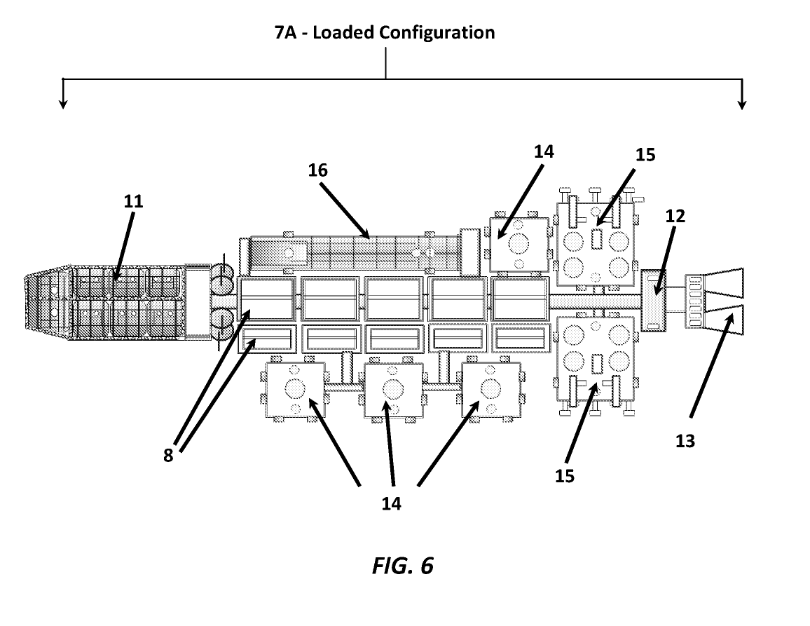

FIG. 7 Operational overview of setting up of an planetary observation environment during a mission deploying planetary satellites 8B, planetary research landing modules 15, and placement and alignment of the Long Haul Optical Communications modules 14. View shows the removal of a satellite 8A from a instrumentation storage container 8 with assistant from remote controlled drone 2.

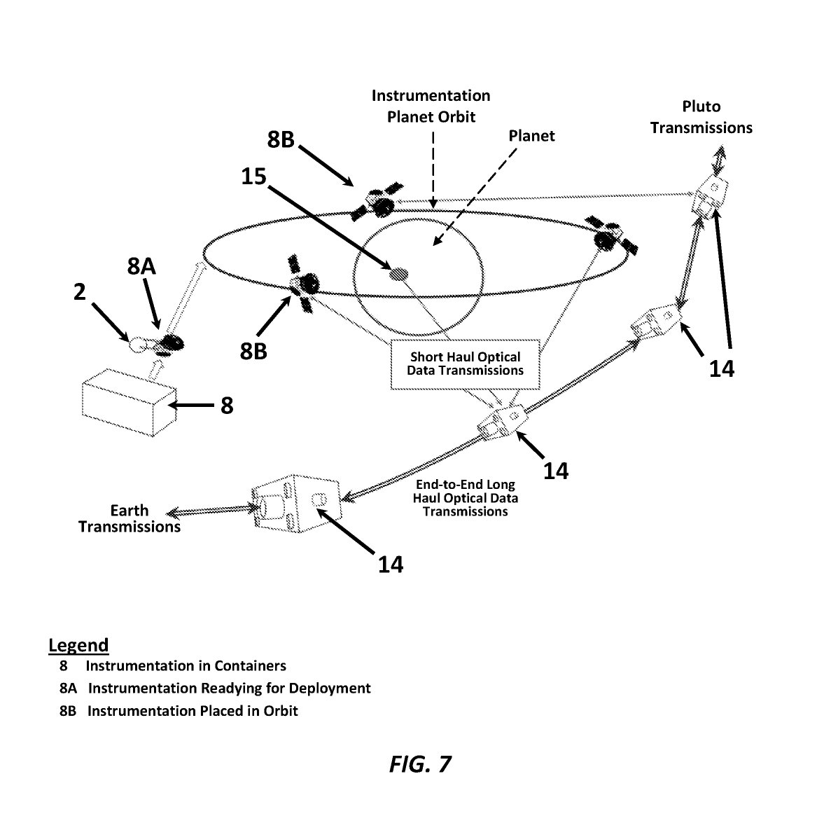

FIG. 8 Operational mission overview of entire conceptual multi-destination instrumentation delivery to 6 planets and moons. Details of this mission are highlighted at FIGS. 7 and 9.

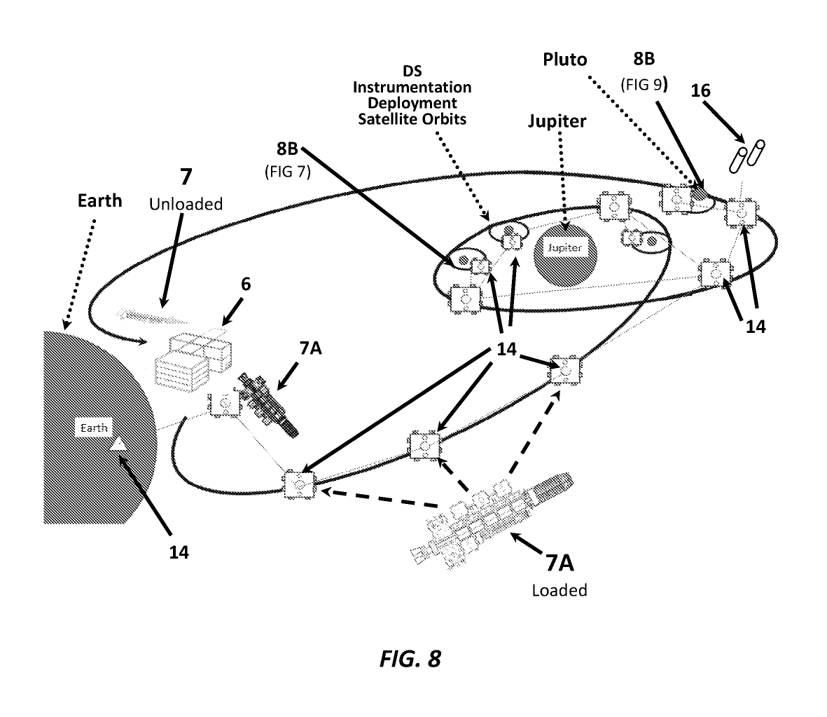

FIG. 9 Operational overview of setting up of an planetary observation environment around and on the surface of Pluto and following the same methods of FIG. 7 Exoplanet research telescopes.

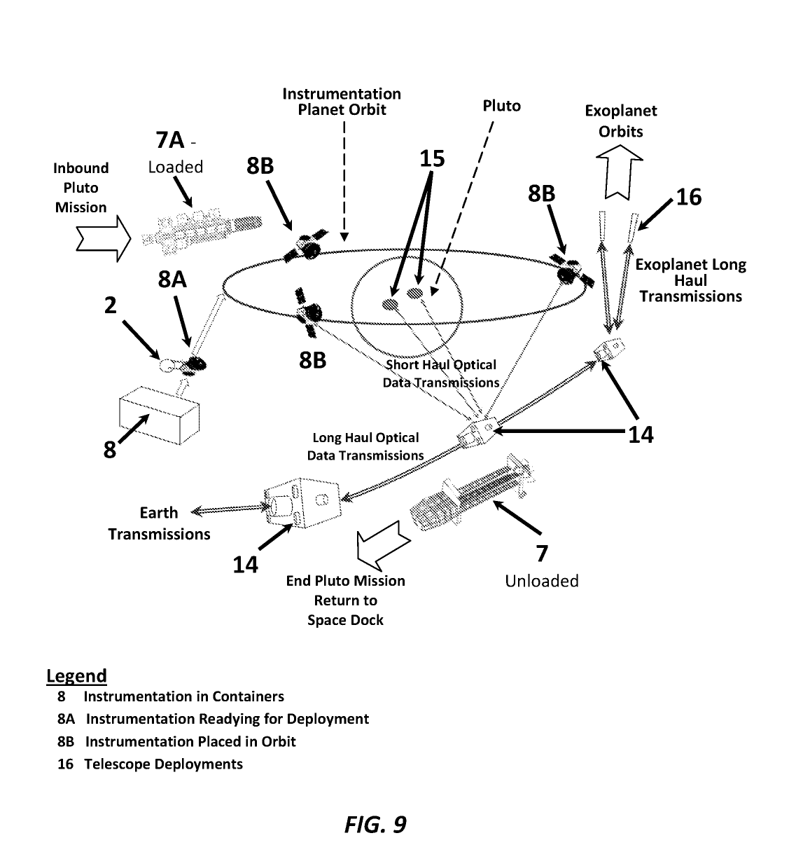

TABLE 1
SSETAC Missions, Goals and Objectives

| SSETAC | Goals supported | Objectives supporting |
|---|---|---|
| Missions | for this Mission | these Goals |
| To Understand | 1. Understand the Earth | 1.4 Catalog and |
| and Protect | system and apply Earth | understand potential |
| Our Home | system science to improve | impact hazards to |
| Planet | prediction of climate, | Earth from space. |
| | weather, and natural | |
| | hazards. | |
| To Explore | 5. Explore the solar system | 5.1 Learn how the |
| the Universe | and the universe beyond, | solar system |
| and Search | understand the origin and | originated and |
| for Life | evolution of life, and search | evolved to its current |
| | for evidence of life | diverse state. |
| | elsewhere | 5.2 Understand how |
| | | life begins and |
| | | evolves and |
| | | determine the |
| | | characteristics of the |
| | | solar system that led |
| | | to the origin of life. |

Table Source: NASA Budget Overview Page ES 2-2 Report, Solar System Exploration

What is claimed is:

1. Method for the following claims that provides a repeatable, structured and documented process flow for bringing a requested commercial or government research project to a mission ready state that comprises the major steps of:
mission planning of requirements definition, mission profile and contracting states;
mission preparation of production, orbital delivery, assemblage, and mission ready state; and
mission execution of loading payloads, begin mission, end mission and return state

2. Method is accordance with claim 1 wherein it is the beginning the mission planning phase is accordance with claim 1 that provides a repeatable, standardized and computer management and discrete tracking of processing steps from project manufacturers and/or suppliers comprising required steps of:
project management, contracting, performance and scheduling;
arrangement and contracting for freight agent forwarders with manufacturers;
freight agent forwarders to pack manufacturers components for delivery;
freight agent forwarders delivery components to specified airport;
freight agent forwarders delivery cargo to airport—update database;
cargo is loaded in an awaiting trans-orbital carrier;
trans-orbital carrier departs for the specified GEO orbital destination; and
completing the mission planning phase upon delivery

3. Method is accordance with claim 2 wherein it is the beginning the mission preparation phase when a trans-orbital carrier(s) arrives to a specified high GEO orbital destination which initiates a computer and remote controlled drones that orchestrates all required steps of:
where drones are guided to a trans-orbital carrier(s) removing the cargo and floating in a sequential method to the assemblage area whether a space dock or delivery system spacecraft;
where drones will assemblage and secure each arriving component together until the software request transport to the mate with other components;
where all assemblage operation follows the traditional modular methods employed by shipbuilding or aircraft company assembly a large ship or aircraft;
where outfitting of any space dock and spacecraft are performing during the assemblage process; and
where assemblage either a space dock and/or spacecraft is at the discretion of the customer or end user

4. Method is accordance with claims 1 and 3 wherein the end state is a fully operational space dock providing a sustainable maintenance orchestrates all required steps of:
providing for a secondary or sister complex and perform secure methods for the large scale production and management of Plutonium 238 (Pu-238) and other fusion materials under Department of Energy (DOE) control, whereas; this complex is to build, overhaul, material dispose, test and inventory Power Package Containers;
sustaining and expanding the commercial and NASA's current supply of Pu-238 and other fusion materials while it negates the need or environmental safety and permits for rocketing small amounts of radioactive materials into space;
enabling the commercial space industry to provide contractor-owned and contractor-operated (CO-CO) facility to develop and expand core capabilities required to implement any DOD, NASA and all commercial client multi-destination strategies using the unloaded spacecraft and turn into a mission ready loaded configuration spacecraft;
providing for a science and engineering environment performing a plurality of methods to fabricate, services, upgrades, disposal of satellites and capabilities to build more advanced and larger telescopes for Exoplanet research;
providing capabilities and develop the advance methods to support an in-situ assemblage and outfitting area to build or modify, test and make ready for a deep space mission in any spacecraft configuration;
providing for continually module expansion for emerging commercial enterprises to accomplish all future anticipated research and construction methods, systems development procedures, construction of any type of spacecraft, planetary habitant/mining infrastructures and asteroid mining;
providing a space dock capabilities for nuclear fusion plasma propulsion systems to relocate to any new solar system planetary locations; and
providing protection of the crew compartments for long term habitation, a complex plurality of methods for radiation protection employing a water barrier is used for scattering properties in gamma-ray protection and combined with other polyethylene/Kevlar composites for other radiation and debris collection protection.

4. Method is accordance with claims 1 and 4 wherein the end state is a fully operational multi-destination instrumentation delivery systems spacecraft that can be outfitted and configured to meet any deep space mission and planetary surface exploration requirements and provide advance methods for:
providing expedite delivery time requires the need for four larger Variable Specific Impulse Magnetoplasma Rocket (VASIMR®) engines and helper Xenon-ION engines for continuous acceleration to the outer solar system and return to earth;
VASIMR® propulsion systems that are fueled by reusable Power Package Containers that when exhausted, the containers are internally stored then returned for the Pu-238 complex overhaul and made ready for reuse;
providing a test bed spacecraft for configuration provides methods, procedures, instrumentation and mounting devices for advanced propulsion systems including Alcubierre Warp Drive Mechanics as conceptualized by Dr. Harold White; and
remain in space or tethered to a space dock to be maintained in an ‘operational state’ and upgraded as new technology and systems are available as new technology and systems are available

5. Method is accordance with claims 1 and 4 wherein a fully operational multi-destination instrumentation delivery systems spacecraft mission has capabilities to deploy and place in planetary orbit satellite instrumentation packages, land planetary modules and heavy construction equipment, planetary human habitation infrastructures, deploy and align optical communication modules
